(19) United States
(12) Patent Application Publication
(10) Pub. No.: US 2021/0197441 A1
(43) Pub. Date: Jul. 1, 2021

(54) A METHOD OF EMBOSSING GLOVE FILM AND A GLOVE FILM PRODUCED THEREFROM

(71) Applicant: Top Glove International Sdn Bhd, Klang (MY)

(72) Inventors: Kon Fah Hue, Klang (MY); Ah Chye Ong, Klang (MY); Tong Aun Ng, Klang (MY); Yoke Meng Tan, Klang (MY); Elaine Nyuk Tzi Chong, Klang (MY)

(73) Assignee: Top Glove International Sdn Bhd, Klang (MY)

(21) Appl. No.: 16/078,544

(22) PCT Filed: Oct. 31, 2017
(86) PCT No.: PCT/MY2017/050068

§ 371 Date: Aug. 21, 2018

(30) Foreign Application Priority Data
Aug. 25, 2017 (MY) PI 2017703151

(51) Int. Cl. B29C 59/04; B29C 59/02

(52) U.S. Cl. CPC B29C 59/04; B29L 2031/4864; B29C 2059/023; B29C 59/022

(57) ABSTRACT

The present invention relates to a method of embossing a glove film comprising the step of passing the glove film between a pair of rollers which are a metal roller and a rubber roller, such that the film has an overlapping texture derived from the metal roller and the rubber roller, wherein the metal roller has a textured surface and the rubber roller has a rough surface.

### FIELD OF INVENTION

The present invention relates to a method of producing glove and particularly to a method of embossing glove film during glove production. More particularly, the present invention describes a method of embossing glove film using a pair of rollers, wherein each roller has a different embossment pattern to produce an overlapping embossment to the glove film.

### BACKGROUND OF INVENTION

Thermoplastic elastomer (TPE) glove has been widely used in the field of food handling, personal care, beauty salon and medical care. In general, to produce a TPE glove, thermoplastic material including but not limited to low density polyethylene (LDPE), metallocene linear low density polyethylene (m-LLDPE), elastomer and supporting additives such as oxidative agent, anti-block and polymer processing aid are initially compounded and blended together in an extruder under controlled temperature profile to produce TPE films Next, the films are extruded and passed between a pair of rollers with smooth surfaces, in which the process is known as embossment process. Subsequently, the films are subjected to pulling, edge trimming, edge winder crosscut, winder and stamping to form the desired glove. The final product from the abovementioned processes is a TPE glove with smooth surface.

The major disadvantage of TPE gloves with smooth surface is their poor gripping and tackiness performance Owing to the smooth surface of the gloves, users may face difficulty in carrying object especially object with slippery surface. Consequently, additional force from the hand of the user is required to grip and hold onto the object of interest. As more gripping force is used, this may cause fatigue to the user's hand and in worst case, inability to hold the object.

The current solution for tackling the poor gripping and tackiness performance issues is by providing a textured TPE glove, whereby the glove is embossed during the film production. The embossment process is one type of calendaring techniques that is widely used on soft fabrics. The embossment of glove generally involves the use of a pair of rollers, wherein the rollers consist of a textured roller and a roller with smooth surface. By embossment, a corresponding embossment pattern from the textured roller is imparted to the glove film to produce the textured film.

Nevertheless, the existing embossment patterns on the TPE glove surface do not effectively resolve the gripping and tackiness performance of the glove. Improvement in the gripping and tackiness properties has been demonstrated to be mild. Further, the existing embossment method has also been reported to affect the glove strength, whereby when the glove is embossed, the thickness of embossed glove portion is reduced, thereby rendering it susceptible to tearing. In view of the above, it is therefore desirable to provide an embossment method that could significantly enhance the gripping properties of the TPE glove. Moreover, it is also desirable to provide an embossment method that does not significantly affect the glove strength.

### SUMMARY OF INVENTION

The main aspect of the present invention is to provide a method of embossing glove film that could enhance gripping performance of the finished product.

Another aspect of the present invention is to provide a method of embossing glove film that improves tackiness of the glove especially those made of thermoplastic elastomer (TPE) polymer.

Still another aspect of the present invention is to provide a method of embossing glove film that does not significantly affect the glove strength.

Yet another aspect of the present invention is to provide a method of embossing glove film that provide easy donning property to user.

At least one of the preceding aspects is met, in whole or in part, by the present invention, in which the embodiment of the present invention describes a method of embossing a glove film comprising the step of passing the glove film between a pair of rollers which are a metal roller and a rubber roller, such that the film has an overlapping texture derived from the metal roller and the rubber roller, wherein the metal roller has a textured surface and the rubber roller has a rough surface.

Preferably, the textured surface of the metal roller has an embossment pattern comprising shapes of diamond, octagonal wave, jewel and square.

Preferably, the rough surface of the rubber roller is produced by grinding process.

According to a preferred embodiment, the metal roller has an average surface roughness of more than about 100 μm.

According to another preferred embodiment, the rubber roller has an average surface roughness of more than about 15 μm.

Preferably, a glove prepared by the embossment method of the present invention has an average surface roughness of about 15-30 μm and an embossment depth of 80-120 μm.

The present preferred embodiment of the invention consists of novel features and a combination of parts hereinafter fully described and illustrated in the accompanying drawings and particularly pointed out in the appended claims; it being understood that various changes in the details may be effected by those skilled in the arts but without departing from the scope of the invention or sacrificing any of the advantages of the present invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 shows the embossment process using textured metal roller and rough surfaced rubber roller to form a textured film.

FIG. 2 shows the embossment pattern on the surface of the textured metal roller according to one of the preferred embodiment.

FIG. 3 shows the embossment pattern on the surface of the rough surfaced rubber roller according to one of the preferred embodiment.

FIG. 4 shows the embossed pattern on the surface of a glove film embossed using the method of present invention according to one of the preferred embodiment.

FIG. 5 shows the changes in thickness of glove film during embossment process.

### DETAILED DESCRIPTION OF THE INVENTION

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

The present invention relates to a method of embossing a glove film comprising the step of passing the glove film between a pair of rollers which are a metal roller and a rubber roller, such that the film has an overlapping texture derived from the metal roller and the rubber roller, wherein the metal roller has a textured surface and the rubber roller has a rough surface.

The glove film used in the present invention is preferably made of elastomer based material such as thermoplastic elastomer (TPE), but other suitable types of thermoplastic material such as polyolefin, styrene-block copolymer and styrene-ethylene block copolymer may also be included.

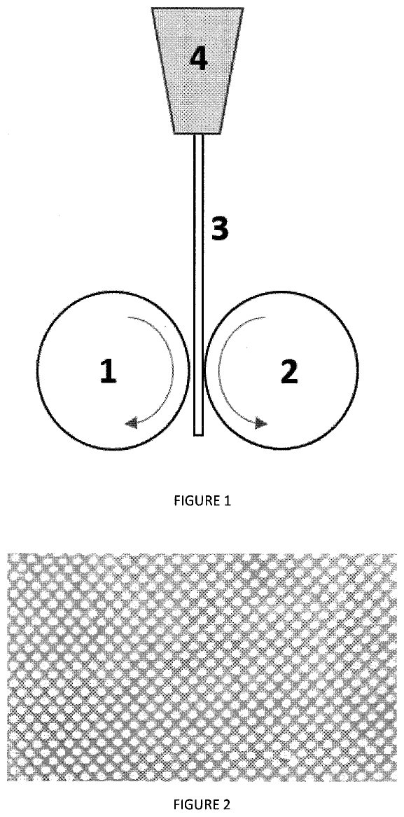

Referring to FIG. 1, a glove film (3) is freshly extruded from an extruder (4) and passed between a pair of rollers for embossment. Preferably, the freshly extruded glove film is in a semi solid form and have high tendency of deformation in order to ease the shaping of the film. It is preferred that the freshly extruded glove film is passed through the pair of rollers to provide a film of relatively uniform thickness. Preferably, the pair of rollers used in the embossment process are a metal roller (1) and a rubber roller (2). According to the preferred embodiment, the metal roller has a textured surface while the rubber roller has a rough surface.

FIG. 2 shows the textured surface of the metal roller according to a preferred embodiment. The embossment pattern on the textured surface of the metal roller preferably comprising a multiplicity of discrete embossments in a regular array. Preferably, the embossments are of similar shape and configuration, wherein the preferred shape includes but not limited to shapes of diamond, octagonal, wave, jewel and square. Other suitable embossment patterns such as turtle, lattice, hemp satin and jewel beetle may also be included. In accordance with the present invention, the textured metal roller preferably has an average surface roughness of more than 100 μm. More preferably, the average surface roughness of the textured metal roller is about 100-400 μm.

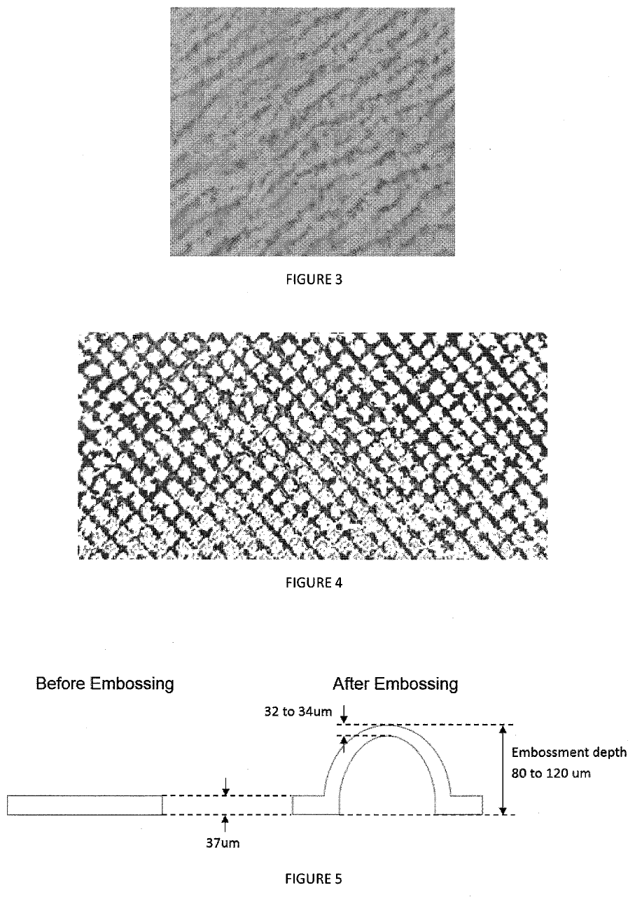

As illustrated in FIG. 3, the rubber roller has a rough surface provided by a plurality of particles of hard rubber material. In accordance with a preferred embodiment, the rough surface on the rubber roller is preferably produced by grinding process. Preferably, the rubber roller is ground to achieve an irregular rough surface. It is preferable that the irregular rough surface is produced using grinding stone, blade cutter or any suitable grinding tools. Further, it is preferable that the rough surfaced rubber roller has an average surface roughness of more than 15 μm. More preferably, the average surface roughness of the rubber roller is about 15-30 μm.

As shown in FIG. 4, the finished glove film produced using the embossment method of the present invention has an overlapping embossment pattern imparted from the embossment of both the textured metal roller and the rough surfaced rubber roller. The shape of embossment appears to vary widely across the surface of the film. Besides, the overlapping embossment pattern renders the glove film to appear shiny and thereby potentially providing aesthetic effect to the glove. The visually shiny effect of the embossed glove film also provides convenience to the user to differentiate the glove of the present invention from other glove products.

To produce a glove using the embossed glove film of the present invention, the glove film is subjected to pulling station, edge trimming, edge winder crosscutter, winder and stamping. Preferably two layers of the embossed glove film are stamped and sealed under suitable temperature, pressure and heat to form a functional embossed glove. Pursuant to the preferred embodiment, the embossed glove is preferred to have an average surface roughness of about 15-30 μm in order to provide good gripping performance More preferably, the average surface roughness of the embossed glove is about 25 μm.

Further, the embossment is preferably applied on at least one surface of the glove. More preferably, the embossment is applied on both the outer surface and the inner surface of the glove. In the preferred embodiment, the embossed glove has a low value of coefficient of friction (COF) on the inner surface and a high value of COF on the outer surface. It will be well appreciated by those skilled in the art, that by providing such embossed gloves, the user could easily don the gloves with good tackiness property.

As embossment is known to affect the glove strength, therefore surface modification agent has been commonly used during the production of embossed gloves. However, in accordance with the present invention, no additive is required for producing the embossed gloves as described in the preceding description. This is achieved by providing the embossed gloves with a suitable embossment depth, which is preferably about 80-120 μm. By having such embossment depth, the thickness of the glove will not be adversely affected during the embossment process as illustrated in FIG. 5. Thus, when the gloves are donned by user and used for long period of time, it will not easily susceptible to tearing.

Although the invention has been described and illustrated in detail, it is to be understood that the same is by the way of illustration and example, and is not to be taken by way of limitation. The spirit and scope of the present invention are to be limited only by the terms of the appended claims.

### Examples

An example is provided below to illustrate different aspects and embodiments of the invention. The example is not intended in any way to limit the disclosed invention, which is limited only by the claims.

### Gripping and Tackiness Analyses of Gloves

The gripping and tackiness performances of the embossed glove of the present invention are compared to glove without embossment. The comparison results are shown in TABLE 1.

TABLE 1

| | TPE glove | Embossed glove |
|---|---|---|
| | with smooth | of present |
| Categories | surface | invention |
| Static COF (Gripping) | 0.10 to 0.20 | 0.35 to 0.65 |
| Kinetic COF (Donning) | 0.15 to 0.18 | 0.15 to 0.25 |
| Tackiness test (°) | 0 to 60 | 0 to 90 |

TABLE 1 showed the gripping and tackiness performance of TPE glove with smooth surface and embossed glove of present invention.

### Physical Properties of Gloves

The physical properties of the embossed gloves of the present invention are compared to glove without embossment. The comparison results are shown in TABLE 2.

TABLE 2

| | Thickness (μm) | | Tensile Strength (MPa) | | Elongation (%) | |
|---|---|---|---|---|---|---|
| | Before | After | Before | After | Before | After |
| Glove (weight) | embossing | embossing | aging | aging | aging | aging |
| ASTM D882-12 | Nil | | Min. 12 | Min. 12 | Min. 550 | Min. 550 |
| Standard | | | | | | |
| TPE glove with | 36 to 38 | 40 to 50 | 24.0 to 26.0 | 27.0 to 30.0 | 575 to 650 | 570 to 630 |
| smooth surface | | | | | | |
| Embossed glove of | 36 to 38 | 45 to 60 | 23.0 to 24.5 | 26.0 to 29.5 | 575 to 630 | 570 to 620 |
| present invention | | | | | | |

TABLE 2 showed the physical properties comparison of TPE glove with smooth surface and embossed glove of present invention.

### Coefficient of Friction Analysis of Gloves

The coefficient of friction is measured on the exterior and interior surface of gloves. The coefficient of friction of the embossed glove of the present invention (Sample No. 3) is compared and the comparison results are shown in TABLE 3.

TABLE 3

| Glove | | | Coefficient of Friction | |
|---|---|---|---|---|
| Sample | Rubber | Metal | Glove | Glove |
| No. | roller | roller | Exterior | Interior |
| 1 | Smooth surface | Smooth surface | 0.10 to 0.20 | 0.15 to 0.18 |
| 2 | Smooth surface | Textured surface | 0.25 to 0.40 | 0.30 to 0.45 |
| 3 | Rough surface | Textured surface | 0.35 to 0.65 | 0.15 to 0.25 |

TABLE 3 showed the coefficient of friction of 3 different glove samples including the embossed glove of the present invention (Sample No. 3).

1. A method of embossing a glove film, comprising the step of:
passing the glove film between a pair of rollers, wherein the pair of rollers includes a metal roller and a rubber roller, such that the glove film has an overlapping texture derived from the metal roller and the rubber roller, wherein the metal roller has a textured surface and the rubber roller has a rough surface.

2. The method according to claim 1, wherein the textured surface of the metal roller has an embossment pattern comprising shapes of diamond, octagonal, wave, jewel and square.

3. The method according to claim 1, wherein the rough surface of the rubber roller is produced by grinding process.

4. The method according to claim 1, wherein the metal roller has an average surface roughness of more than 100 μm.

5. The method according to claim 1, wherein the rubber roller has an average surface roughness of more than 15 μm.

6. A glove film embossed using a method according to claim 1 and having an average surface roughness of 15-30 μm.

7. A glove film embossed using a method according to claim 1 and having an embossment depth of 80-120 μm.
